(19) United States
(12) Patent Application Publication
(10) Pub. No.: US 2015/0111052 A1
(43) Pub. Date: Apr. 23, 2015

(54) WATER-RESISTANT FLAME-RESISTANT COMPOSITIONS

(71) Applicant: WEYERHAEUSER NR COMPANY, Federal Way, WA (US)

(72) Inventors: Erik M. Parker, Bonney Lake, WA (US); Jack G. Winterowd, Puyallup, WA (US); Glen Robak, Meridian, ID (US)

(73) Assignee: WEYERHAEUSER NR COMPANY, Federal Way, WA (US)

(21) Appl. No.: 14/057,723

(22) Filed: Oct. 18, 2013

(51) Int. Cl. C08K 5/521; C09D 113/02; C09K 21/14

(52) U.S. Cl. CPC C08K 5/521; C09K 21/14; C09D 113/02
USPC 428/514; 524/144

(57) ABSTRACT

The present disclosure provides compositions formulated to provide water resistance and fire resistance when applied as a coating to a surface (e.g., the surface of a wood product). The compositions include a latex binder and a halogenated phosphate ester. Wood products treated with the composition, as well as methods for applying the composition to a surface, are also provided.

### BACKGROUND

One way to improve the fire-safety of buildings is to follow construction guidelines for fire prevention and damage mitigation, which include detailed recommendations regarding structural design, assemblies, sprinkler systems, smoke detectors, and other factors influencing how a fire might start and spread throughout a building. In addition, companies that manufacture building materials from wood have taken steps to make their products inherently more fire-safe. Some companies have experimented with coating or impregnating wood products with fire-retardant chemical treatments. Examples of such treatments are described in U.S. Pat. Nos. 6,245,842 and 5,968,669, the disclosures of which are hereby incorporated by reference in their entirety.

For wood products used in construction there are two main tests used to qualify wood assemblies and wood products as fire-resistant materials in the building codes. The first test is the ASTM E119 “Fire Tests of Building Construction and Materials,” which measures the ability of the product to maintain its load bearing capacity during a fire. The second test is the ASTM E2768 “Surface Burning Characteristics of Building Materials,” which requires a 30-minute burn on an ASTM E84 flame spread test set-up. The E2768 test measures the ability of the material to resist or slow the propagation of a flame along its surface. Coatings that perform well in one of these ASTM tests do not necessarily perform well in the other. For example, a coating that is relatively non-combustible may prevent the spread of a flame along its surface, but may do very little to protect the substrate from structural heat degradation. Such a coating would perform well in the E84 test but perform poorly in an E119 test. Conversely, a coating that rapidly expands when exposed to heat or flame may not prevent a flame from traveling along its surface.

Although conventional fire-resistant coatings can help improve fire-performance, they are not without shortcomings. Many commercially available treatments protect wood from flame spread and/or direct combustion; however, they do not provide much improvement in extending the time a wood product can sustain a structural load in a fire event. In a building application, premature failure can occur in some load carrying wood products subjected to a fire event. Extending the duration these products can sustain structural loads in a fire event would provide additional time for the occupants to vacate the building. In addition, some of the conventional treatments applied do not provide the required durability for the wood product. For example, during the construction process, water durability can be particularly advantageous. In addition, many treatments that can achieve the desired results are very expensive and cost prohibitive to manufacture on a large scale. Finally, many treatments require reductions in design values of the treated wood product.

Thus, there is a need in the industry to develop improved coatings for wood products that provide fire-resistant properties. Specifically, there is a need to develop fire-resistant coatings for wood products that remain effective when exposed to prolonged exposure to water and extend the time these products can sustain a structural load during a fire event thus providing for improved occupant safety. In addition, a durable fire-resistant coating that slows flame spread would also be very useful.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a composition having water resistance and fire resistance is provided. In one embodiment, the composition includes: a latex binder; and a halogenated phosphate ester.

In another aspect, a wood product having water resistance and fire resistance is provided. In one embodiment, the wood product includes: a wood product having at least one surface; and a composition as disclosed herein disposed on at least a portion of the at least one surface.

Further aspects include methods for applying the composition (e.g., as a coating on a surface of a wood product).

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIGS. 1 and 2 are side cross sectional views of I-joists coated with a composition according to embodiments of the disclosure;

FIGS. 3 and 4 are side cross sectional views of wood products coated with a composition according to embodiments of the disclosure;

FIGS. 5 and 6 are photographs of wood products coated with compositions according to embodiments of the disclosure and subjected to a scrape test after being submerged in water; and

FIG. 7 is a photograph of a wood product coated with a comparative composition and subjected to a scrape test after being submerged in water.

### DETAILED DESCRIPTION

The present disclosure describes compositions formulated to provide water resistance and fire resistance when applied as a coating to a surface (e.g., the surface of a wood product).

Certain specific details are set forth in the following description and FIGURES to provide a thorough understanding of various embodiments of the disclosure. Well-known structures, systems, and methods often associated with such systems have not been shown or described in detail to avoid unnecessarily obscuring the description of various embodiments of the disclosure. In addition, those of ordinary skill in the relevant art will understand that additional embodiments of the disclosure may be practiced without several of the details described below. Certain terminology used in the disclosure is defined as follows:

“Wood product” is used to refer to a product manufactured from logs, such as lumber (e.g., boards, dimension lumber, solid sawn lumber, joists, headers, beams, timbers, moldings, laminated, finger jointed, or semi-finished lumber), composite wood products, or components of any of the aforementioned examples.

“Composite wood product” is used to refer to a range of derivative wood products which are manufactured by binding together the strands, particles, fibers, or veneers of wood, together with adhesives, to form composite materials. Examples of composite wood products include but are not limited to glulam, plywood, parallel strand lumber (PSL), oriented strand board (OSB), oriented strand lumber (OSL), laminated veneer lumber (LVL), laminated strand lumber (LSL), particleboard, medium density fiberboard (MDF), cross-laminated timber, and hardboard.

“Intumescent particles” refer to materials that expand in volume and char when they are exposed to fire.

The term “about” is used herein to modify a related value by +/−5%.

When applied to wood products, the provided compositions provide water resistance. As used herein, the term “water resistance” refers to a treated state of the wood product wherein the wood product passes a “24-Hour Water Soak Test” as described in the EXAMPLES below. Briefly, the coated wooden specimen is submerged in water for 24-hours. The coating must adhere to the substrate and should be difficult to rub off when wet.

When applied to wood products, the provided compositions also provide improved fire resistant properties. As used herein, the term “fire resistance” refers to a treated state of the wood product wherein the treated wood product is less susceptible to burning. In some embodiments the improved fire resistance of the product can be measured using the E84 test. Any improvement over an untreated product in this test is considered improved fire resistance. An increase in time to ignition when the treated product is exposed to a flame compared to an untreated product is another way to measure an improvement in fire resistance. In certain embodiments, the composition provides fire-retardant-treated (FRT) qualification of the wood product based on the extended E-84 (30 min.) test for fire-retardant-treated wood (International Building code §2303.2).

Flame-spread and smoke-developed indexes are determined in the E84 test. These results are grouped in classes. There are A, B, and C ratings as well as a fire-retardant-treated wood rating. Some of the embodiments of the provided composition as a coating on a wood product are designed to meet the fire-retardant-treated wood rating. Section 2303.2 of the International Building Code states that fire-retardant-treated wood shall have a listed flame spread index of 25 or less and show no evidence of significant progressive combustion when the test is continued for an additional 20-minute period. In addition, the flame front shall not progress more than 10.5 feet beyond the centerline of the burners at anytime during the test. Other embodiments may provide a lower level of fire resistance by providing a Class A rating or a reduced time to ignition.

Turning now to the compositions, in one aspect, a composition having water resistance and fire resistance is provided. In one embodiment, the composition includes: a latex binder; and a halogenated phosphate ester.

The components of the provided compositions will now be described. Unless noted otherwise, the percentages listed for particular components are based on the final weight of the composition when applied as a solid coating, as opposed to the portion of a dispersion containing the composition prior to application on a wood product. Additionally, the term “about” is used herein to modify a related value by +/−5%.

### Latex Binder

The latex acts as a binder for the other materials in the composition, and in some cases is a continuous phase. It binds the materials together and adheres them to the wood product onto which the composition is applied. Because latexes are waterborne they offer health and environmental benefits compared to solvent-borne or two-component urethanes.

Latex formulations are also generally one component. This allows for any solid fire-resistant materials used in a composition to be dispersed with all of the liquid. Conversely, in a two component polyurethane system all of the solid fire retardant materials are dispersed in the polyol side of the formulation, which makes it more viscous and difficult to spray or pump.

A latex binder also is not reactive to water. In a two component polyurethane system, absorbed moisture on solid components can contribute to carbon dioxide formation and foaming problems during the curing of the coating.

Latex binders are also often diluted with water. This increases the volume of the formulation but since the water evaporates it does not become part of the cured coating. This increases the solid component/binder ratio. Because the binder is an organic polymer, it will burn without additional fire retardants, and thus keeping the amount of binder to a minimum improves fire-resistance performance.

There are many latex binders suitable for use with the disclosed embodiments. Representative latex binders include emulsion polymers comprised of addition polymer micelles dispersed in a continuous water phase. Typically, the latex system contains surfactants which serve to improve the phase stability of the emulsion. The polymer is made by free radical polymerization of unsaturated monomers, which may include but are not limited to, acrylic acid, acrylic esters, styrene, butadiene, methacrylic acid, methacrylate esters, and/or acrylonitrile. Commonly, small amounts of free radical initiators are added to the monomers at the beginning of the polymerization process. These emulsion polymers can be alkaline or acidic.

Specific examples of latex binders include polyacrylics, such as Raycryl 1020 and Raycryl 1001, manufactured by Specialty Polymers, Inc.; and Rovene 4021 manufactured by Mallard Creek Polymers, Inc. These are typically mixed with water, thickeners, and viscosity modifying agents.

In one embodiment, the latex binder is an acrylic (e.g., polyacrylic) latex. In one embodiment, the latex binder is present from about 15% to 75% by weight. In one embodiment, the latex binder is present from about 15% to 40% by weight. In one embodiment, the latex binder is present from about 20% to 35% by weight.

### Halogenated Phosphate Ester Component

The compositions include a halogenated phosphate ester. The halogenated phosphate esters include compositions known to those of skill in the art having a phosphate ester moiety and at least one terminal halogen moiety.

The halogenated phosphate ester can perform several functions. Not wishing to be bound by theory, it is proposed that the halogenated phosphate ester component has the following effects. First, the halogenated phosphate ester, when combined with the latex component creates a more water-durable binder than the latex alone. Halogenated compounds and phosphates are both used in fire retardant systems. Halogenated phosphate esters are specifically used in two component urethane foam formulations to reduce flame spread. Although the authors are not aware of any instance where halogenated phosphate esters are used as part of a latex paint formulation, the halogenated phosphate ester is still capable of following a fire retarding degradation pathway when exposed to heat and flame.

In certain embodiments, the halogenated phosphate ester reacts with the latex. While the specific chemical reaction mechanism is not known, the dramatic improvement of water resistance demonstrated by adding a halogenated phosphate ester to a latex, as illustrated in the EXAMPLES below, indicates a chemical transformation. For example, the halogenated phosphate ester may crosslink the latex. Therefore, in one embodiment, a crosslinked latex is provided, wherein the crosslinking is effected by the halogenated phosphate ester. However, in other embodiments, the latex does not react with the halogenated phosphate ester.

One other potential mechanism for the improvement of the properties of compositions as a result of the addition of the halogenated phosphate ester with the latex includes the halogenated phosphate ester acting as a plasticizer for the latex. Yet another potential mechanism includes the halogenated phosphate ester acting as a coalescing aid with the latex.

In one embodiment, the halogenated phosphate ester is a chlorinated phosphate ester. While tris chloroalkyl phosphate esters are described primarily herein, it should be appreciated that other halogenated phosphate esters (e.g., mono- and di-esters) can also be used. For example, as long as a single halogenated ester is conjugated to the phosphate, the compound can be used in the compositions provided herein. In certain embodiments, a halogen atom is directly bound to the phosphorous at one or more positions.

For example, tris chloroalkyl phosphate esters of various alkyl lengths (e.g., ethyl, propyl, butyl, etc.) having straight or branched configurations. A presently preferred chlorinated phosphate ester is tris(2-chloroisopropyl)phosphate (CAS number 13674-84-5).

Mixtures of phosphate esters can also be used. For example, SaFRon 6605 is a proprietary mixture from ICL Industrial Products. The exact composition of the mixture is stated as proprietary on the technical data sheet, but the MSDS lists tris(2-chloroisopropyl)phosphate as 20-50 percent of the mixture and an aliphatic brominated alcohol as 25-80 of the mixture.

In one embodiment, the halogenated phosphate ester is selected from the group consisting of tris(1,3-dichloroisopropyl)phosphate, oligomeric chloroalkyl phosphate esters, chlorinated phosphate ester blends, brominated phosphate esters, tris(2-chloroisopropyl)phosphate, diethyl bis(hydroxyethyl)aminomethyl phosphonate, diethyl-N,N-bis(2-hydroxyethyl), tris(4-bromophenyl)phosphate, dicresyl 4-bromophenyl phosphate, 2,4-dibromophenyl 2-ethylcresyl phosphate, 2,4-dibromophenyl methyl phosphate, diethyl 4-bromophenyl phosphate, and other product containing both phosphorus and a halogen. A commercial example is the chlorinated phosphate ester known as Fyrol PCF (ICL Industrial Products, Israel).

In one embodiment, the halogenated phosphate ester compound is present from about 0.1% to 40% by weight. In one embodiment, the halogenated phosphate ester compound is present from about 1% to 20% by weight. In one embodiment, the halogenated phosphate ester compound is present from about 1% to 10% by weight.

Certain halogenated phosphate esters are also liquid at room temperature, which can aid in controlling viscosity of the composition. Therefore, in certain embodiments, the halogenated phosphate ester in the composition is a liquid.

Other Components

In addition to the latex component and the halogenated phosphate ester component, the compositions according to embodiments of the disclosure may contain other additives. Additives that may be incorporated into the compositions to achieve beneficial effects include, but are not limited to, intumescent particles, smoke suppressants, halogenated fire retardants, synergists that work in combination with halogenated fire retardants, compounds adapted to undergo endothermic decomposition, surfactants, wetting agents, opacifying agents, colorants, viscosifying agents, catalysts, preservatives, biocides, fillers, diluents, hydrated compounds, halogenated compounds, acids, bases, salts, melamine, and other additives that might promote the production, storage, processing, application, function, cost, and/or appearance of the composition as a coating for wood products.

One additive that is useful to incorporate into the composition is intumescent particles, which improves fire endurance. Intumescent particles suitable for use with embodiments of the disclosure include expandable graphite, which is graphite that has been loaded with an acidic expansion agent (generally referred to as an “intercalant”) between the parallel planes of carbon that constitute the graphite structure. When the treated graphite is heated to a critical temperature, the intercalant decomposes into gaseous products and causes the graphite to undergo substantial volumetric expansion. Manufacturers of expandable graphite include GrafTech International Holding Incorporated (Parma, Ohio). Specific expandable graphite products from GrafTech include those known as Grafguard® 160 50, Grafguard® 220 50, and Grafguard® 160 80. Other manufacturers of expandable graphite include HP Materials Solutions, Incorporated (Woodland Hills, Calif.). Further, other types of intumescent particles known to a person of ordinary skill in the art would be suitable for use with embodiments of the disclosure.

In one embodiment, the intumescent particles are present in the range of about 1 to 40%. In one embodiment, the intumescent particles are present in the range of about 5 to 30%. In one embodiment, the intumescent particles are present in the range of about 10 to 25%.

Another additive that may be particularly useful to incorporate into the composition is micron-sized silica, including fumed silica and precipitated silica. Fumed silica is generally produced by pyrolysis of silicon tetrachloride or from quartz sand vaporized in a 3000° C. electric arc. It is commercially available from the Cabot Corporation (Boston, Mass.) under the trade name Cab-O—Sil®. Precipitated silica is generally produced by addition of sulfuric acid to aqueous sodium silicate solutions. Precipitated silica is commercially available from Evonik Industries (Hanau-Wolfgang, Germany) under the trademark Sipernat®. The silica can be incorporated into the formulation at a level of 0.01% to 15% on a weight basis of the dried coating. The addition of micronized silica to the formulation may improve the toughness and durability of the coating after it has intumesced. Physical toughness may be beneficial because combustion events can involve fairly turbulent air currents. If a coating on a wood product intumesces during a fire and is too delicate in this expanded form, then it can be simply blown off of the wood product, which would compromise or eliminate its protective effect.

In one embodiment, the composition further comprises one or more additives, the one or more additives selected from the group consisting of: intumescent particles, halogenated fire retardants, synergists that work in combination with halogenated fire retardants, compounds adapted to undergo endothermic decomposition, silica, surfactants, wetting agents, opacifying agents, colorants, viscosifying agents, catalysts, preservatives, biocides, fillers, diluents, hydrated compounds, halogenated compounds, acids, bases, salts, and melamine.

Another group of additives that may be useful to incorporate into the compositions are halogenated compounds (in addition to the halogenated phosphate ester), which are well-known to provide fire resistance to compositions. Brominated compounds are particularly well known to provide fire resistance and will be described here. However, it will be appreciated that other halogenated compounds (e.g., chlorinated compounds) are also contemplated.

In one embodiment, the composition includes brominated compounds sufficient to provide improved surface burning characteristics, according to the E-84 test. That is, the compositions of this embodiment allow for longer E-84 burn times than similar compositions without the brominated compounds and halogenated phosphate ester.

The brominated compound can be an ester but not a phosphate ester. For example a tetrabromophthalate ester (BroFlam 45-Z from Polymer Additives Group). Any brominated compound can be considered a fire retardant. These include products like Emerald innovation 3000, Emerald innovation 1000, BA59p (all supplied by Great Lakes Solutions). In one embodiment, the halogenated compounds are fire-resistant brominated compounds.

Representative brominated compounds include tetrabromophthalate ester, brominated neopentyl alcohol, brominated bisphenol A, brominated polymers such as Emerald innovation 3000 or Emerald Innovation 1000 from Great Lakes Solutions, ammonium bromide, brominated diphenyl ethers, brominated polyols such as PH4T or PH4T-lv from Great Lakes Solutions, brominated lignin, dibromostyrene, copolymers of dibromostyrene such as Firemaster CP44-HF from Great Lakes Solutions, tetrabromophthalic anhydride, derivatives of tetrabromophthalic anhydride such as Firemaster BZ-54 or Firemaster BZ-54HP both from Great Lakes Solutions, tetrabromobenzoate ester or compositions based on tetrabromobenzoate esters such as Firemaster 550,552,600,602 from Great Lakes Solutions, Hexabromocyclododecane, stabilized hexabromocyclododecane, phenoxy-terminated carbonate oligomers of tetrabromobisphenolA such as BC-51 and BC-58 from Great Lakes Solutions, tribromophenol, and tribromophenyl alkyl ether.

In one embodiment the brominated compounds are present from about 1 to 30%. In one embodiment the brominated compounds are present from about 1 to 20%. In one embodiment the brominated compounds are present from about 1 to 10%. In one embodiment the brominated compounds are present from about 5 to 15%.

In a further embodiment, the brominated compounds are present in an amount related to the actual content of bromine present in the composition. Therefore, bromine-dense compounds may be present in less total weight than bromine-light compounds but still provide the same amount of bromine. In one embodiment, the bromine compound includes 5 to 85% bromine, based on molecular weight. In one embodiment, the bromine compound includes 15 to 80% bromine, based on molecular weight. In one embodiment, the bromine compound includes 25 to 70% bromine, based on molecular weight.

In another embodiment, the brominated compounds include molecules having a plurality of bromine atoms.

Furthermore, the bromine content of the composition can be defined according to the overall mass of bromine in the formulation. In one embodiment, the total mass of bromine in the dried coating is between 0.5% and 20%. In another embodiment, the total mass of bromine in the dried coating is between 1% and 15%. In another embodiment, the total mass of bromine in the dried coating is between 2% and 10%. Brominated compounds sufficient to provide the recited mass of bromine in the dried coatings is provided in the composition.

The amount of bromine in the dried coating is correlated with performance in the E-84 flame spread test. With reference to the EXAMPLES, a coating known as WE84-161, which contains less bromine by mass than the coatings known as WE84-187G and WE84-192G achieved a Class A rating (10 minutes), while the WE84-187G and WE84-192G coatings achieved the E2768 (30 minute) rating. The amount of bromine by mass in the dried WE84-192G coating is about 26% greater than in WE84-161. Bromine content can be increased or decreased depending on the desired level of performance. Bromine levels can be increased without having a detrimental effect on the 24 hour soak test.

The brominated compounds can be solid or liquid.

Additives that act synergistically with halogenated compounds to reduce flaming combustion are also useful in the composition. Well-known compounds that act synergistically with halogens are antimony compounds, such as antimony trioxide, antimony pentaoxide, colloidal antimony pentoxide, sodium antimonite or other antimony-metal compounds, antimony compounds that contain silicone or phosphorous, and mixtures of the above compounds. In one embodiment, the antimony compound is present from about 0.1% to 20%. In one embodiment, the antimony compound is present from about 1% to 15%. In one embodiment, the antimony compound is present from about 1% to 10%.

Other minerals and compoundssuch as halloysite, borate compounds such as zinc borate, zinc hydroxy stannate, zinc stannate, zinc metaborate, ammonium octamolybdate, and molybdenum oxide can be used in place of or in combination with antimony compounds.

Still another group of materials that are useful to incorporate into the composition are compounds that follow an endothermic degradation pathway, such as aluminum trihydrate magnesium hydroxide, huntite, hydromagnesite, and mixtures thereof.

Yet a further group of materials that are useful to incorporate into the compositions are compounds that evolve non-combustible gasses when heated. These compounds include hydrated compounds like disodium octaborate tetrahydrate, borax decahydrate, or similar hydrated compounds, as well as melamine, which is not hydrated but gives off nitrogen when it decomposes.

In one embodiment, the compound that undergoes an endothermic decomposition process when exposed to heat or flame is present in the range of about 1 to 70%. In one embodiment, the compound that undergoes an endothermic decomposition process when exposed to heat or flame is present in the range of about 5 to 50%. In one embodiment, the compound that undergoes an endothermic decomposition process when exposed to heat or flame is present in the range of about 10 to 40%.

Dispersions of the Composition

The compositions provided herein may be applied from a dispersion. In one embodiment, the composition is formulated as a dispersion. The dispersion contains the components of the composition along with one or more suitable liquids. The dispersion includes solvated and/or suspended components of the composition.

Representative solvents include water or any liquid capable of properly solvating and/or dispersing all of the components of the composition. In one embodiment, the dispersion is an aqueous dispersion.

In one embodiment, the dispersion is formulated to be applied to a wood product. In order to be applied to a wood product, the dispersion must be compatible with manual or machine-based application methods known to those of skill in the art. Particularly, the viscosity and concentration of the dispersion must be such that the composition can be applied to a surface of the wood product evenly and in a controlled amount such that the final, solid coating of the composition on the surface has the weight composition of each component as provided herein. Representative dispersions are described further below in the EXAMPLES section.

Application of Coating

Coatings of the composition according to embodiments of the disclosure may be applied to a number of different products. As a non-limiting example, such coatings may be applied to wood products. Generally, coatings according to embodiments of the disclosure are applied to one or more surfaces of a wood product. In certain embodiments, coatings may be applied to a portion of one or more surfaces of the wood product. In certain embodiments, entire surfaces, or the entire surface, of wood product may be covered. In certain embodiments, the fire-resistant coating covers approximately 50% to approximately 100% of the product's surface area.

In one embodiment, the composition is disposed on a surface of a wood product.

In one embodiment, the surface of the wood product with the composition is flame-spread resistant such that it would pass the E2768 (30 minute) flame spread test.

In one embodiment, the wood product is selected from the group consisting of: I-joists, trusses, solid sawn lumber, parallel strand lumber (PSL), oriented strand board (OSB), oriented strand lumber (OSL), laminated veneer lumber (LVL), laminated strand lumber (LSL), particleboard, and medium density fiberboard (MDF).

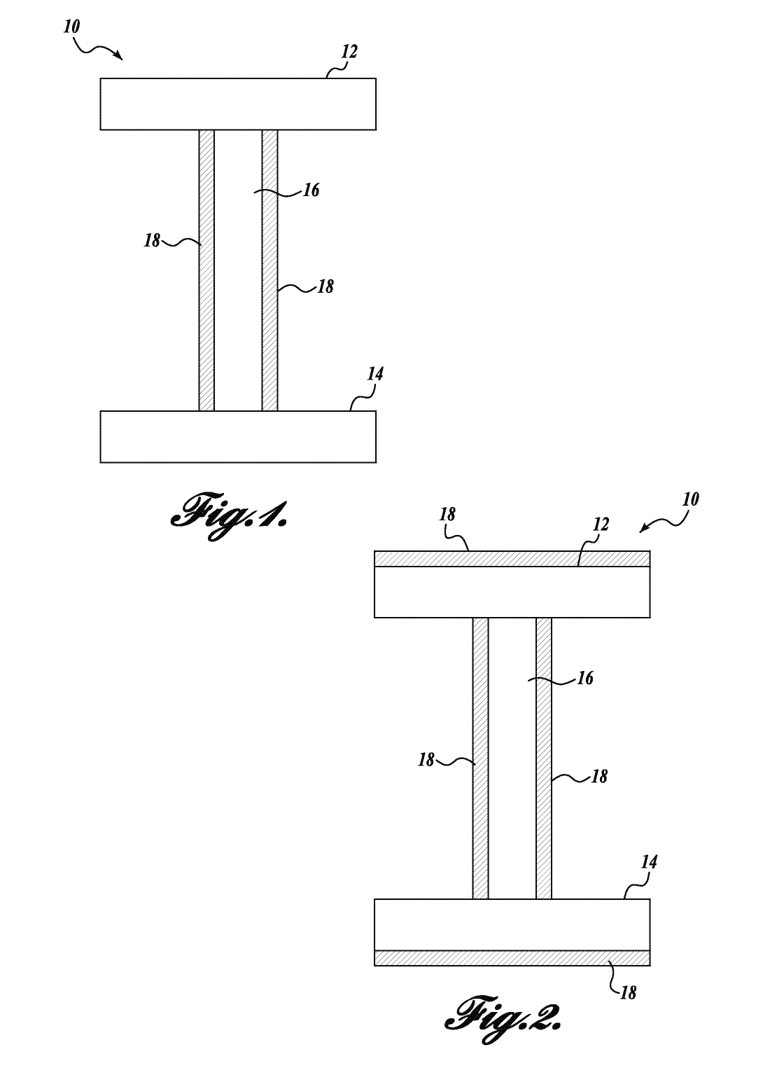

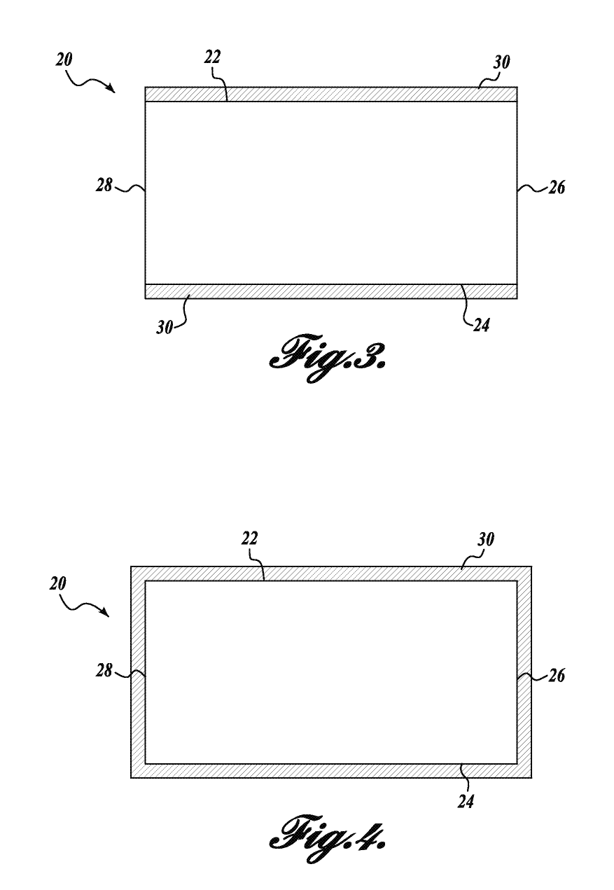

FIGS. 1-4 depict wood products having coatings of the compositions according to embodiments of the disclosure. FIGS. 1 and 2 show an I-joist 10 having a top flange 12, a bottom flange 14, and a webstock member 16 connecting the top flange 12 to the bottom flange 14. In FIG. 1, the webstock member 16 is shown completely coated in a coating 18 of a composition according to embodiments of the disclosure. Typically, any wood surface that is expected to be exposed to heat (e.g., fire) is coated. In certain embodiments, only a portion (e.g., 50% to 90%) of the webstock member 16 is coated. Although not explicitly shown in FIG. 1, some portion of overspray may be applied to the top flange 12 and/or the bottom flange 14.

Referring to FIG. 2, the I-joist 10 is shown in a state similar to that of FIG. 1, but also with the top flange 12 and the bottom flange 14 coated with the composition according to embodiments of the disclosure. In certain embodiments, the coating covers 10% to 50% of the I-joist surface area. In other embodiments, the coating covers 51% to 100% of the I-joist surface area. A person of ordinary skill in the art will appreciate that numerous different application configurations for I-joists not shown explicitly in FIGS. 1 and 2 are within the scope of this disclosure.

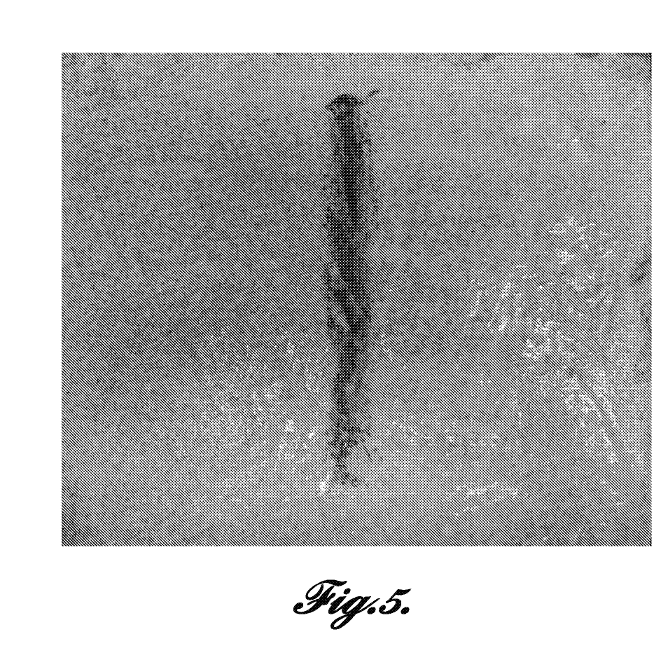

Referring to FIGS. 3 and 4, a wood product 20 is shown having a first surface 22, a second surface 24, a third surface 26, and a fourth surface 28. The wood product 20 may be any type of wood product, including but not limited to solid sawn lumber, parallel strand lumber (PSL), oriented strand board (OSB), oriented strand lumber, laminated veneer lumber (LVL), laminated strand lumber (LSL), particleboard, and medium density fiberboard (MDF). A person of ordinary skill in the art will appreciate that wood products according to this disclosure may have shapes other than those explicitly shown in the Figures.

Referring to FIG. 3, only the first surface 22 and the second surface 24 of the wood product 20 is coated with a coating 30 of a composition according to embodiments of the disclosure. The entire surfaces 22 and 24 may be coated or a portion may be coated.

In certain situations, it may be cost effective to coat only a portion of a surface of the wood product 20. For example, it is also possible that application of the coating 30 to a wood product 20 used as a building material could interfere with the ability of the wood product 20 to be connected or fastened, such as by nailing or screwing, to other building materials. In this situation, complete coverage of all of the exposed surface area on the wood product 20 may be undesirable.

Referring to FIG. 4, all four surfaces (the first surface 22, the second surface 24, the third surface 26, and the fourth surface 28) are coated with the coating 30. In certain situations, it may be desirable to cover each surface entirely or to cover only a portion of each surface. In certain embodiments, the coating 20 covers 10% to 50% of the wood product 20 surface area. In other embodiments, the coating 20 covers 51% to 100% of the wood product 20 surface area. A person of ordinary skill in the art will appreciate that numerous different application configurations for wood product 20 not shown explicitly in FIGS. 3 and 4 are within the scope of this disclosure.

It will also be appreciated that coatings made according to embodiments of the disclosure may be applied to different types of wood products other than those explicitly illustrated. For example, coatings may be applied to trusses or joists having any known configuration. In certain embodiments, wood products coated according to the disclosure include single sawn pieces of wood products, or products having specific shapes. As a non-limiting example, coatings according to the disclosure may be applied to a variety of wood products (e.g., trusses) having a top flange, bottom flange, and one or more web stock members.

The application level of the coating may generally be in the range of 300 g/m² to 3000 g/m².

The preferred coating application level may depend on the product to which the coating is applied, the intended use, and performance requirements. In certain situations, minimal protection of the wood product might be needed and a relatively low spread rate may be suitable. In other situations (e.g., an exposed floor assembly), a higher application rate may be appropriate.

Coatings according to embodiments of the disclosure may be applied with any equipment known to those of skill in the art, such as spray systems, extruders, curtain coaters, and roll coaters, and other application equipment. In certain embodiments, coatings according to embodiments of the disclosure may be applied to any surface area described herein as a series of discrete beads using an extruder or another equivalent apparatus. Such beads may each be approximately ⅛ of an inch to approximately 1 inch in diameter and may be spaced so that they are approximately ⅛ of an inch to approximately ¼ of an inch apart.

In certain embodiments, the coating is applied manually with a hand-held knife or brush.

Although this disclosure explicitly describes applications of coatings to wood products, a person of ordinary skill in the art will appreciate that coatings made according to embodiments of the disclosure may be applied to different types of materials. As a non-limiting example, coatings of the provided compositions may be applied to other types of construction materials, including but not limited to wood/plastic composites, gypsum, steel (including light-gauge steel framing and steel beams and columns), aluminum (ducting), and concrete. Furthermore, coatings according to embodiments of the disclosure may be applied to surfaces other than constructions materials in any situation where the properties of the composition may be beneficial. Additionally, while the compositions have both low-flame spread properties, as well as water resistance, the compositions may be used in applications that require only one of those two properties.

Words in the above disclosure using the singular or plural number may also include the plural or singular number, respectively. For example, the term “wood product” could also apply to “wood products.” Additionally, the words “herein,” “above,” “below,” and words of similar import, when used in this application, shall refer to this application as a whole and not to any particular portions of this application. When the word “or” is used in reference to a list of two or more items, that word covers all of the following interpretations of the word: any of the items in the list, all of the items in the list, and any combination of the items in the list.

From the foregoing, it will be appreciated that the specific embodiments of the disclosure have been described herein for purposes of illustration, but that various modifications may be made without deviating from the disclosure. For example, the compositions according to the disclosure may be impregnated in wood products or may be applied in a manner that is not considered a coating. In addition, coatings according to the disclosure may be used for reasons other than their low flame-spread properties.

Aspects of the disclosure described in the context of particular embodiments may be combined or eliminated in other embodiments. For example, aspects of the disclosure related to I-joists may be combined with aspects of the disclosure related to other wood products. Further, while advantages associated with certain embodiments of the disclosure may have been described in the context of those embodiments, other embodiments may also exhibit such advantages, and not all embodiments need necessarily exhibit such advantages to fall within the scope of the disclosure. Accordingly, the invention is not limited except as by the appended claims.

The following examples will serve to illustrate aspects of the present disclosure. The examples are intended only as a means of illustration and should not be construed to limit the scope of the disclosure in any way. Those skilled in the art will recognize many variations that may be made without departing from the spirit of the disclosure.

### EXAMPLES

Coating Compositions

A coating similar to those of the disclosed embodiments, although not containing a halogenated phosphate ester, was prepared as follows.

When the coatings were prepared, dispersions of hydroxyethyl cellulose (HEC) and a latex were prepared first. The HEC dispersion was prepared in the following manner; 965 grams of warm (20° C.) water was added to a 200 mL glass beaker. 30 grams of hydroxy ethyl cellulose was added, and this was mixed at high speed using a cowls blade for 20 minutes. After the water and HEC were mixed, 5.0 g of 28% ammonium hydroxide was added and the dispersion was mixed for another 8 minutes.

The coatings were first prepared as a dispersion according to the formulation table below.

WE84-177 (Comparative Coating)

| | Mass Percent in | |
|---|---|---|
| Component | Formulation | Mix Conditions |
| Water | 20 | 3 min cowls blade on high |
| Aluminum trihydrate | 17 | 3 min cowls blade on high |
| Antimony trioxide | 07 | 3 min cowls blade on high |
| Hydroxyethyl cellulose | 09 | 3 min cowls blade on high |
| solution | | |
| Acrylic latex, | 35 | 3 min cowls blade on high |
| not modified | | |
| Fumed silica | 01 | |
| Intumescent particles | 12 | By hand |

Exemplary Coatings

When the coatings were prepared, dispersions of hydroxyethyl cellulose (HEC) and a latex modified with the halogenated phosphate ester were prepared first.

The HEC dispersion was prepared in the following manner; 965 grams of warm (20° C.) water was added to a 200 mL glass beaker. 30 grams of hydroxy ethyl cellulose was added, and this was mixed at high speed using a cowls blade for 20 minutes. After the water and HEC were mixed, 5.0 g of 28% ammonium hydroxide was added and the dispersion was mixed for another 8 minutes. The latex modified with the halogenated phosphate ester was prepared by adding 600 grams of acrylic latex Raycryl 1020 (Speciality Polymers) to a plastic beaker and then adding 80 grams of a chlorinated phosphate ester known as Fyrol pcf. The mixture was mixed at high speed for 3 minutes.

The coatings were first prepared as a dispersion according to the formulation tables below. The only difference between formulations WE84-176 (exemplary) and WE84-177 (comparative) is that in WE84-176 the acrylic latex was first mixed with a halogenated phosphate ester and in WE84-177 the acrylic latex did not contain the halogenated phosphate ester.

The composition of additional exemplary coatings WE84-187G and WE84-192G are also shown in the tables below.

WE84-176 (Exemplary Coating)

| | Mass Percent in | |
|---|---|---|
| Component | Formulation | Mix Conditions |
| Water | 20 | 3 min cowls blade on high |
| Aluminum trihydrate | 17 | 3 min cowls blade on high |
| Antimony trioxide | 07 | 3 min cowls blade on high |
| Hydroxy ethyl cellulose | 09 | 3 min cowls blade on high |
| solution | | |
| Acrylic latex modified | 30.9 | 3 min cowls blade on high |
| with Fyrol pcf according | | |
| to procedure above | | |
| Chlorinated phosphate | 4.1 | |
| ester | | |
| Fumed silica | 01 | |
| Intumescent particles | 12 | By hand |

WE84-187G (Exemplary Coating)

| | Mass Percent in | |
|---|---|---|
| Component | Formulation | Mix Conditions |
| Water | 20 | 3 min cowls blade on high |
| Aluminum trihydrate | 17 | 3 min cowls blade on high |
| Antimony trioxide | 07 | 3 min cowls blade on high |
| Hydroxyethyl cellulose | 08 | 3 min cowls blade on high |
| solution | | |
| Acrylic latex | 27.6 | 3 min cowls blade on high |
| Chlorinated phosphate | 3.6 | Pre-mixed with acrylic latex |
| ester | | |
| Brominated | 2.8 | Pre-mixed with acrylic latex |
| bisphenol A | | |
| Fumed silica | 01 | |
| Intumescent particles | 13 | By hand |

WE84-192G (Exemplary Coating)

| | Mass Percent in | |
|---|---|---|
| Component | Formulation | Mix Conditions |
| Water | 20 | 3 min cowls blade on high |
| Aluminum trihydrate | 17 | 3 min cowls blade on high |
| Antimony trioxide | 07 | 3 min cowls blade on high |
| Hydroxyethyl cellulose | 08 | 3 min cowls blade on high |
| solution | | |
| Acrylic latex | 27.3 | 3 min cowls blade on high |
| Chlorinated phosphate | 3.6 | Pre-mixed with acrylic latex |
| ester | | |
| Brominated | 1.8 | Pre-mixed with acrylic latex |
| bisphenol A | | |
| Emerald Innovation | 1.3 | |
| 3000 | | |
| Fumed silica | 01 | |
| Intumescent particles | 13 | By hand |

WE84-161 (Exemplary Coating)

| Component | Mass % | Mix Conditions |
|---|---|---|
| Water | 21.6 | 3 min cowls blade on high |
| Antimony trioxide | 13.9 | 3 min cowls blade on high |
| 3% soln of HEC | 9.3 | 3 min cowls blade on high |
| Acrylic Emulsion | 30.4 | 3 min cowls blade on high |
| Fyrol PCF | 4.56 | Pre-mixed with acrylic latex |
| PHT4-LV (brominated diol) | 3.04 | Pre-mixed with acrylic latex |
| Cab-o-Sil EH-5 | 0.8 | 3 min cowls blade on high |
| Intumescent particles | 16.4 | By hand |

### 24-Hour Soak Test.

The 24-Hour Soak Test was used to test the water resistance of coatings for wood products. The test includes the following procedure.

An 8″×8″ specimen of OSB is coated with the composition under test. The specimen with the dried coating is then submerged horizontally in the water so that one edge of the OSB specimen is just underneath the water and the other is approximately 8″ under the water. The specimen is left submerged for 24 hours. After the 24 hour time period the specimen is removed from the water and a tongue depressor is used to attempt to scrape the coating off of the specimen. The coating is given a rating of very easy, easy, medium, medium/hard, or hard. This test is performed because wood products are often stored outdoors and the coating must stay intact and still perform after weeks or months of storage.

The 24-Hour Soak Test was performed on WE84-176 (exemplary) and WE84-177 (comparative).

Although the difference between the above two formulations is minor, the result of this 24-Hour Soak Test was dramatic between the two formulations. The exemplary WE84-176 coating containing the latex with the chlorinated phosphate ester was rated as “hard,” indicating that it required a significant amount of force to scrape off the coating. The comparative WE84-177 coating that did not contain the chlorinated phosphate ester was rated as “easy,” indicating that it took very little force to scrape the coating off of the substrate.

Additional exemplary coatings WE84-187G and WE84-192G also both performed well in the 24-Hour Soak Test and were rated “medium-hard.”

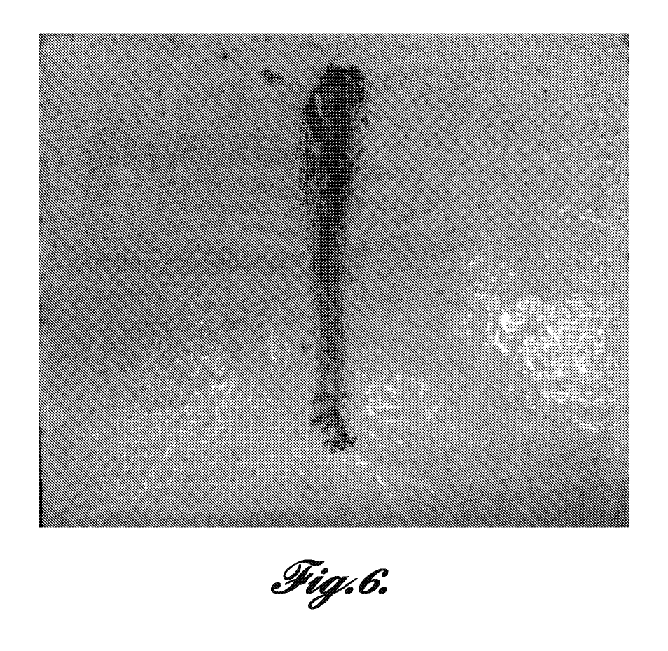

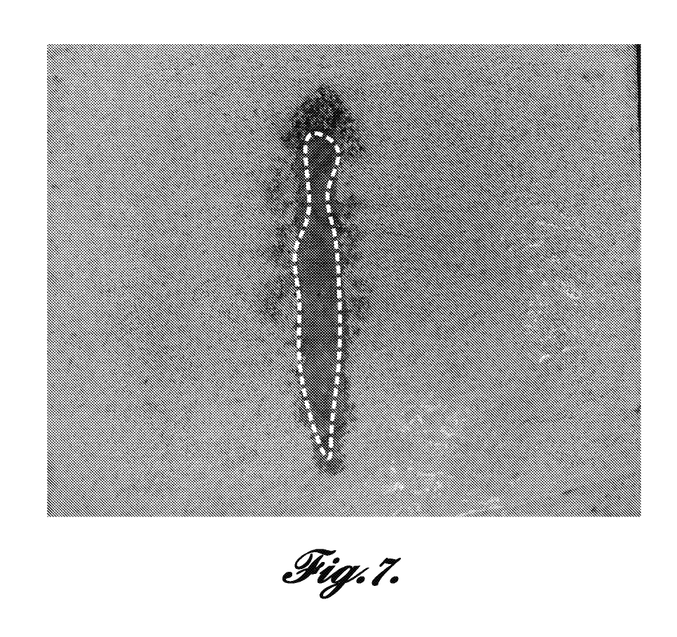

Photographs of WE84-192 and WE84-176 (both Exemplary), as well as WE84-177 (Comparative) applied to an OSB wood product and subjected to the 24-Hour Soak Test are illustrated in FIGS. 5-7, respectively. It can be seen that the Exemplary coatings resist scraping even after soaking in water, with no wood being exposed after the scraping (the dark area of the scratch is intumescent particles, not wood). The Comparative coating easily scrapes completely off to reveal the wood underneath, as illustrated in FIG. 7 in the dashed line, which highlights the border of the wood below the coating.

### Composite Wood Product Flame-Spread Test

Two flame-spread tests were used to test the coatings.

Rimboard Flame-Spread Test.

In this test, coatings were applied to TimberStrand® rimboard at a spread rate of approximately 796.24 grams/m² and subjected to a full-scale E84 flame spread test.

WE84-187G and WE84-192G of the Exemplary Coatings passed the extended (30 minute) E-84 flame spread test (E2768).

The amount of bromine in the dried coating is correlated with performance in the E-84 flame spread test. For example, WE84-161, which contains less bromine by mass than WE84-187G and WE84-192G, achieved a Class A rating (10 minutes), while the WE84-187G and WE84-192G coatings achieved the E2768 (30 minute) rating. The amount of bromine by mass in the dried WE84-192G coating is about 26% greater than in WE84-161.

The Exemplary Coatings passed the E2768 test via the E-84 flame-spread test and kept the flame from spreading more than 10 feet along the surface of the coated TimberStrand® rimboard in a 30 minute time period.

OSB Flame-Spread Test.

Exemplary Compositions were painted onto sections of OSB and tested in a laboratory flame spread screening test where the coating was heated to above 500° F. and was then exposed to the flame of a propane torch.

WE84-187G and WE84-192 G passed the 30-minute E-84 test. WE84-161 passed the 10-minute E-84 test.

The embodiments of the invention in which an exclusive property or privilege is claimed are defined as follows:

1. A composition having water resistance and fire resistance, comprising:
a latex binder, wherein the latex binder is present from about 15% to 75% by weight; and
a halogenated phosphate ester, wherein the halogenated phosphate ester is present from about 0.1% to 40% by weight.

2. The composition of claim 1, wherein the latex binder is an acrylic latex.

3. The composition of claim 1, wherein the latex binder is present from about 15% to 40% by weight.

4. The composition of claim 1, wherein the halogenated phosphate ester is selected from the group consisting of tris(1,3-dichloroisopropyl)phosphate, oligomeric chloroalkyl phosphate esters, chlorinated phosphate ester blends, brominated phosphate esters, tris(2-chloroisopropyl)phosphate, diethyl bis(hydroxyethyl)aminomethyl phosphonate, diethyl-N,N-bis(2-hydroxyethyl), and other product containing both phosphorus and a halogen.

5. The composition of claim 1, wherein the halogenated phosphate ester is present from about 1% to 20% by weight.

6. The composition of claim 1, further comprising intumescent particles.

7. The composition of claim 6, wherein the intumescent particles are present from about 1 to 40% by weight.

8. The composition of claim 1, further comprising a halogenated compound that is not a phosphate ester.

9. The composition of claim 8, wherein the halogenated compound is a brominated compound having fire resistance.

10. The composition of claim 8, wherein the brominated compound is present from about 1 to 30% by weight.

11. The composition of claim 8, wherein the total mass of bromine in the dried coating is between 0.5% and 20%.

12. The composition of claim 1, further comprising an antimony compound.

13. The composition of claim 12, wherein the antimony compound is selected from the group consisting of antimony trioxide, antimony pentaoxide, colloidal antimony pentoxide, sodium antimonite, other antimony-metal compounds, antimony compounds that contain silicone or phosphorous, and mixtures thereof.

14. The composition of claim 12, wherein the antimony compound is present from about 0.1% to 20% by weight.

15. The composition of claim 1, further comprising a compound that undergoes an endothermic decomposition process when exposed to heat.

16. The composition of claim 1, wherein the composition is formulated as a dispersion.

17. The composition of claim 1, further comprising one or more additives, the one or more additives selected from the group consisting of: intumescent particles, halogenated fire retardants, synergists that work in combination with halogenated fire retardants, compounds adapted to undergo endothermic decomposition, silica, surfactants, wetting agents, opacifying agents, colorants, viscosifying agents, catalysts, preservatives, biocides, fillers, diluents, hydrated compounds, halogenated compounds, acids, bases, salts, and melamine.

18. A wood product having water resistance and fire resistance, comprising:
a wood product having at least one surface; and
a composition disposed on at least a portion of the at least one surface, applied to the surface at an application level from 300 g/m² to 3000 g/m²;
wherein the composition comprises:
a latex binder, wherein the latex binder is present from about 15% to 75% by weight; and
a halogenated phosphate ester, wherein the halogenated phosphate ester compound is present from 0.1% to 40% by weight.

19. The wood product of claim 18, wherein the wood product is selected from the group consisting of I-joists, trusses, glulam, solid sawn lumber, parallel strand lumber (PSL), oriented strand board (OSB), oriented strand lumber (OSL), laminated veneer lumber (LVL), laminated strand lumber (LSL), particleboard, cross-laminated timber, hardboard, and medium density fiberboard (MDF).

20. The wood product of claim 18, wherein the surface of the wood product with the composition is flame-spread resistant such that it would pass the E2768 flame spread test.
